(19) United States
(12) Patent Application Publication
(10) Pub. No.: US 2011/0106783 A1
(43) Pub. Date: May 5, 2011

(54) MOBILE SEARCH WITH A LANDMARK

(76) Inventor: Srinivas KALBHAVI, Bangalore (IN)

(21) Appl. No.: 12/611,819

(22) Filed: Nov. 3, 2009

(51) Int. Cl. G06F 17/30; G06Q 30/00

(52) U.S. Cl. 707/706; 705/14.73; 707/E17.108; 715/864

(57) ABSTRACT

A wireless handset and method for enabling the wireless handset to determine an address with a landmark is described. The method includes receiving a first search text string from a keyboard associated with the wireless hands and receiving a second landmark text string from the keyboard, wherein the landmark text string is associated with a landmark having a particular location. The method then proceeds to process the first search text string and the second landmark text string. The first search text string and the second landmark text string are communicated to a search engine using a wide area network. A search result is generated that has at least one address that corresponds to the search term and the landmark.

### FIELD OF THE INVENTION

The present invention relates to a wireless handset and method for enabling the wireless handset to perform a mobile search with a landmark. More particularly, the invention relates to a first search text string associated with a search term such as a shop, a second landmark text string associated with a landmark having a particular location, and a search result that corresponds to the search term and the landmark.

### BACKGROUND

Generally, the process of locating an address using a search engine or map-based website requires providing an accurate address for the location. If the user does not have the correct address, it is difficult to locate the address with the search engine or map-based website. Additionally, results generated by present-day search engines are unable to adequately obtain an accurate address for a particular location.

The process of locating an address using a search engine or map-based website is further complicated with mobile phones because mobile phones have less processing power and a small display screen. Additionally, the latency associated with accessing the mobile web makes it challenging to interact with a search engine or map-based website. Furthermore, there are challenges associated with interacting with the wireless device because the relatively small display makes it difficult to analyze search results.

For example, a user interacts with a search engine by accurately inputting an address or zip code. If an accurate address is provided, the search engines location based service application will search the complete address and point to a given location.

Current search engines do not have the option to search a given address based on a landmark. Therefore, it would be beneficial to provide a system and method that enables the user to perform a location based search using on a landmark. It would also be beneficial to enable the user to perform more effective searches by using landmarks that enable the user to conduct a more effective search. Furthermore, it would be beneficial to reduce the processing power required by mobile phones because the mobile search process is made more efficient.

### SUMMARY

A wireless handset operatively coupled to a network that enables the wireless device to communicate with a search engine is described. The wireless device includes a processor, a keyboard operatively coupled to the processor and configured to receive a plurality of text, and a display operatively coupled to the processor, in which the display presents the text received by the keyboard. A first search text string is received from the keyboard. The first search text string is associated with a search term such as a shop. Additionally, a second landmark text string is received from the keyboard and the landmark text string is associated with a landmark having a particular location. The wireless handset provides a means for communicating the first search text string and the second landmark text string to the search engine using the network. A search result is then received that includes a search result having at least one address that corresponds to the search term and the landmark.

The illustrative wireless handset may also include a third search string that associates a distance and/or a direction with the first search text string and the second landmark text string. Additionally, the wireless handset may include a map that is displayed on the wireless handset and the map displays the location for each of the search results. Furthermore, the wireless handset may associate an advertisement with the search results corresponding to the landmark. Further still, the advertisement may include an offer from a similar shop.

A method for enabling a wireless handset to determine an address with a landmark is described. The method includes receiving a first search text string from a keyboard associated with the wireless handset and receiving a second landmark text string from the keyboard, wherein the landmark text string is associated with a landmark having a particular location. The method then proceeds to process the first search text string and the second landmark text string with a processor corresponding to the wireless handset that is operatively coupled to the keyboard and a display. The first search text string and the second landmark text string are presented on the display and communicated to a search engine using a wide area network. A search result is generated that has at least one address that corresponds to the search term and the landmark. In the illustrative embodiment, the first search text string is associated with a shop.

The method may also receive a third search string that includes a distance search string and/or a directional search string associated with the first search text string and the second landmark text string. The method may also include generating a map that displays the location for each of the search results. Additionally, an advertisement may be associated with the search results corresponding to the landmark. Furthermore, the advertisement may include an offer from a similar shop.

### DRAWINGS

The present invention will be more fully understood by reference to the following drawings which are for illustrative, not limiting, purposes.

FIG. 1 shows an illustrative wireless handset.

FIG. 2 shows an illustrative communication system, in which the wireless handset communicates using a variety of different standards and accesses a wide area network that communicates with a search engine.

FIG. 3 shows an illustrative flowchart of the method for enabling the wireless handset to perform a mobile search with a landmark.

FIGS. 4A-4D present illustrative screenshots for enabling the wireless handset to perform a mobile search with a landmark.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A wireless handset, system and method for determining a location by referencing a landmark is described herein. A landmark as used herein is a prominent identifying feature of a landscape. The wireless handset, system and method access a dedicated search application that provides the user with a search address based on the landmark. The “search address” refers to the searching for the place or the name of the place where a person, organization, or this like is located or may be reached.

For example, if a user knows the name of a shop that was recently visited and has forgotten the complete the address of the shop, the user can input a first search text string that is associated with the shop and a second landmark text string. Additionally, there may be more than landmark text string. Thus, the second landmark text string may present two or more landmarks

The dedicated search application will subsequently help the user find the correct address. Additionally, the dedicated search application may also include a third text search string that associates a distance and/or a direction with the first search text string and the second landmark text string. There may be instances where the third text search string includes two or more distance terms, directional terms, or a combination of distance and directional terms. The dedicated search application may then continue by communicate to a third party that the landmark was used to perform a search. The landmark text string may then be presented to as a keyword that is used for advertising.

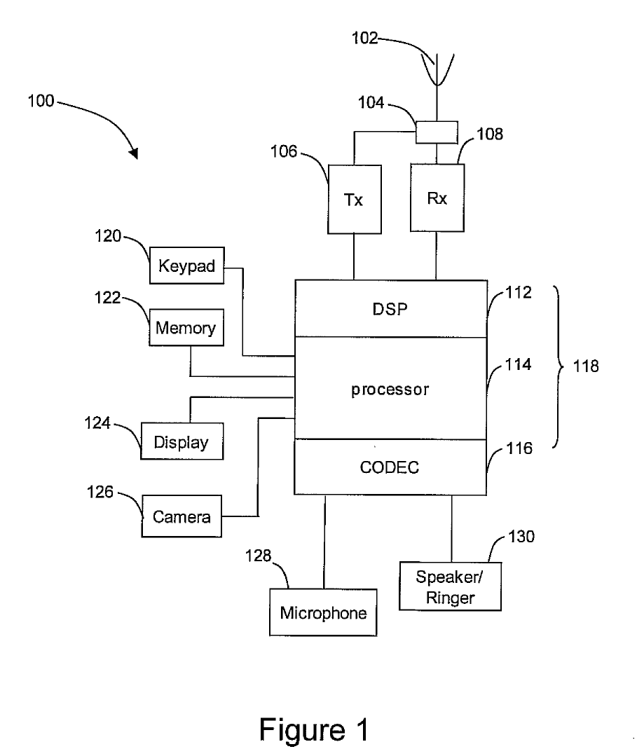

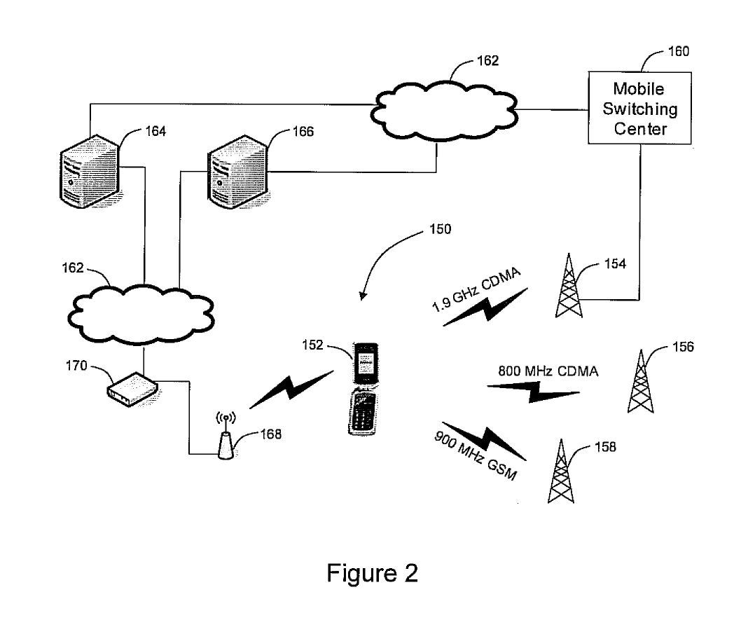

Referring to FIG. 1 there is shown a plurality of components associated with an illustrative wireless handset that determine a location by referencing the landmark. The illustrative wireless handsets 100 and 152 (shown in FIG. 2) can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system. It shall be appreciated by those of ordinary skill in the art that the term wireless communication device, wireless handset, mobile handset, wireless phone, and mobile phone are interchangeable.

The illustrative multimode wireless handset 100 comprises a first antenna element 102 that is operatively coupled to a duplexer 104, which is operatively coupled to a multimode transmitter module 106, and a multimode receiver module 108. The antenna element 102 may be mounted on either the display housing (not shown), the keypad housing (not shown), or a combination thereof.

An illustrative control module 118 comprises a digital signal processor (DSP) 112, a processor 114, and a CODEC 116 that are communicatively coupled to the transmitter 106 and receiver 108. It shall be appreciated by those of ordinary skill in the art that the transmitter module and receiver module are typically paired and may be embodied as a transceiver. The DSP 112 may be configured to perform a variety of operations such as controlling the antenna 102, the multimode transmitter module 106, and the multimode receiver module 108.

The processor 114 is operatively coupled to a keypad 120, memory 122, display 124 and camera 126. Additionally, the processor 112 is also operatively coupled to a CODEC module 116 that performs the encoding and decoding operations and is communicatively coupled to microphone 128 and a speaker or ringer 130. The CODEC module 116 is also communicatively coupled to the display 124 and provides the encoding and decoding operations for video.

In operation, the illustrative wireless handset 100 receives a first search text string from the keyboard 120. The first search text string is associated with a search term such as a shop. Additionally, a second landmark text string is received from the keyboard 120 and the landmark text string is associated with a landmark having a particular location. The wireless handset 100 provides a means for communicating the first search text string and the second landmark text string to the search engine using a network 162 (shown in FIG. 2). A search result by the wireless handset 100 that includes a search result having at least one address that corresponds to the search term and the landmark.

The illustrative wireless handset 100 may also be configured to receive a third search string that associates a distance and/or a direction with the first search text string and the second landmark text string. Further, the illustrative wireless handset 100 may also be configured to receive a third text search string that associates a distance, direction, or distance and direction with the first search text string and the second landmark text string. Additionally, the wireless handset 100 may present a map that is displayed on the wireless handset and the map displays the location for each of the search results. Furthermore, the wireless handset 100 may associate an advertisement with the search results corresponding to the landmark or landmarks. Further still, the advertisement may include an offer from a similar shop.

Referring to FIG. 2 there is shown an illustrative communication system 150 that enables a wireless handset 152 to perform a mobile search with a landmark. The illustrative wireless communication device 152 communicates using a variety of different standards.

In the illustrative system 150, the wireless communication device 152 is a wireless handset that is configured to communicate with one or more base stations 154, 156 and 158 using different communication access technologies (CATs). Each CAT receiver module complies with a wireless standard having a receiver requirement. By way of example and not of limitation, the wireless standard is selected from the group of standards consisting of Code Division Multiple Access (CDMA), Global System for Mobile communications (GSM), Universal Mobile Telecommunications System (UMTS), Universal Mobile Broadband (UMB), wireless local area network (WLAN), wireless personal area network (WPAN), Mobile Broadband Wireless Access (MBWA) and Worldwide Interoperability for Microwave Access (WiMAX) or IEEE802.16.

The illustrative base stations may communicate with the wireless handset using a variety of different communication standards including, but not limited to, various forms of code division multiple access (CDMA), orthogonal frequency division multiple access (OFDMA), and time division multiple access (TDMA) wireless interfaces. By way of example and not of limitation, the wireless handset 152 communicates with base station 154 using a CAT that operates using CDMA technology at 1.9 GHz. Additionally, the wireless handset 152 is also configured to communicate with base station 156 using a CAT that operates using CDMA at 800 MHz. Furthermore, the illustrative handset 152 is configured to communicate with base station 158 using a CAT that operates using GSM technology at 900 MHz.

The illustrative base stations 154, 156 and 158 are operatively coupled to mobile switching center 160. The mobile switching center 160 is configured to communicate with a wide area network 162 such as the Internet. The wide area network 162 provides access to a plurality of illustrative server 164 that performs a dedicated search operation. The search application performed by server 164 receives a first search text string that may be associated with the shop and a second landmark text string corresponding to a particular location. Additionally, the dedicated search application may also include a third search string that associates a distance and/or a direction with the first search text string and the second landmark text string. The dedicated search application subsequently help the user find the correct address.

The dedicated search application may then continue by communicate to a third party server 166 and inform the third party server that the landmark was used to perform a search. The landmark text string may then be presented used for advertising by having the landmark be converted to a keyword that may be used for advertising.

The wireless handset 152 is also configured to access a wireless local area network (WLAN) that may include a Wi-Fi access point 168 that is operatively coupled to a modem 170 that provides access to the illustrative wide area network 162 and illustrative servers 164 and 166. Thus, the WLAN may also be used to access the dedicated search operation described above.

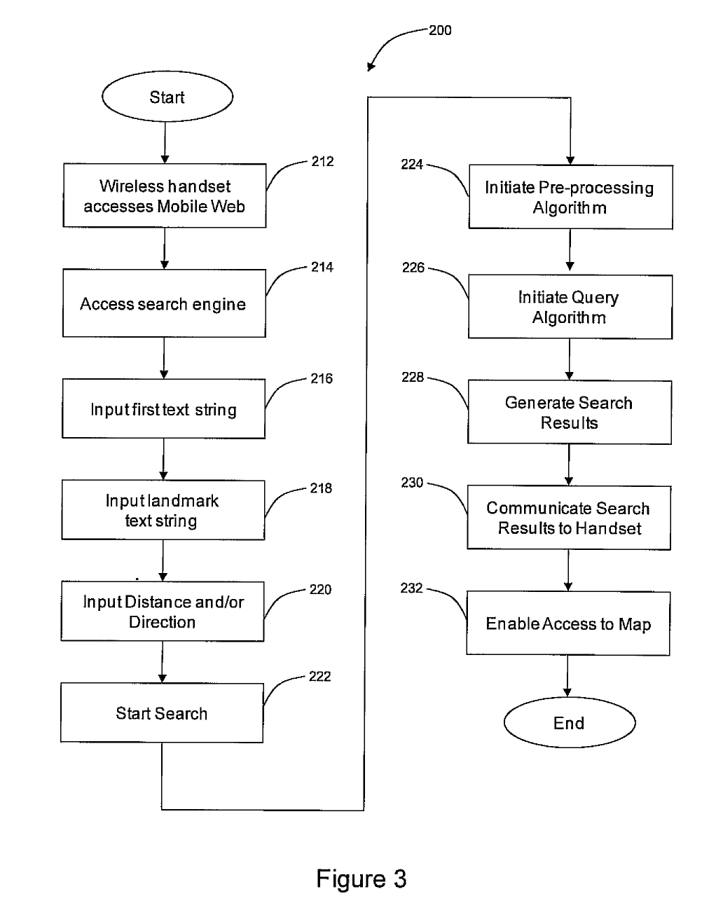

Referring to FIG. 3 there is shown an illustrative flowchart 200 of the method for enabling for enabling a wireless handset to determine an address with a landmark. The illustrative flowchart is initiated at block 212 by the wireless handset accessing the mobile web via network cloud 162 (in FIG. 2). Alternatively, a personal computer (PC), a tablet PC or other such device may access the illustrative World Wide Web. Typically, a browser is used as an interface for accessing the search application described above.

The method then proceeds to block 214 where a search engine is accessed by the illustrative wireless handset 100. At block 216, the method receives a first search text string from keyboard 120. By way of example and not of limitation, the first search text string is associated with a shop or store such as Starbucks® or Levi's®. The first search text string may also be associated with a descriptive term such as “book store,” “parking lot,” “restaurant,” “garage,” and other such descriptive terms that may be input into the wireless handset 100.

At block 218, the method receives a second landmark text string from the keyboard. The second landmark text string may include one or more landmarks. As described above the landmark is associated with a prominent identifying feature of a landscape. Thus, the landmark text string is associated with at least one landmark having a particular location and can support a variety of different landmarks. By way of example and not of limitation, illustrative landmarks include “airport,” “museum,” “football stadium,” “hospital” and other such terms.

At block 220, the method receives a third search text string that includes a distance search text string and/or a directional search text string associated with the first search text string and the second landmark text string. The third search text string may receive one or more distance and/or directional terms. In one illustrative embodiment, a third distance search string that associates a distance with the first search text string and the second landmark text string is received by the wireless handset. In an alternative embodiment, a third directional search string associates a direction with the first text string and the second landmark text string. In yet another illustrative embodiment, either the distance string search or the directional search string is received. In still another illustrative embodiment, both the distance string search and the directional search string are received. In still another illustrative embodiment, the relative landmark string search, the distance string search and the directional string search are received. By way of example and not of limitation, an illustrative third search string employs terms such as “near,” “far,” “distance,” “left,” “right,” “perpendicular,” “diagonal,” “toward,” “away from,” “between,” and other such terms.

At block 222, the dedicated search operation is performed and the search is initiated. The search engine may then proceed to perform a preprocessing algorithm at block 224, in which the landmark text string is associated with a particular landmark having a particular location. At block 226, a query algorithm is initiated where the first search text string is used to perform a search query. The search results generated at block 228 provides at least one address that corresponds to the search term and the landmark.

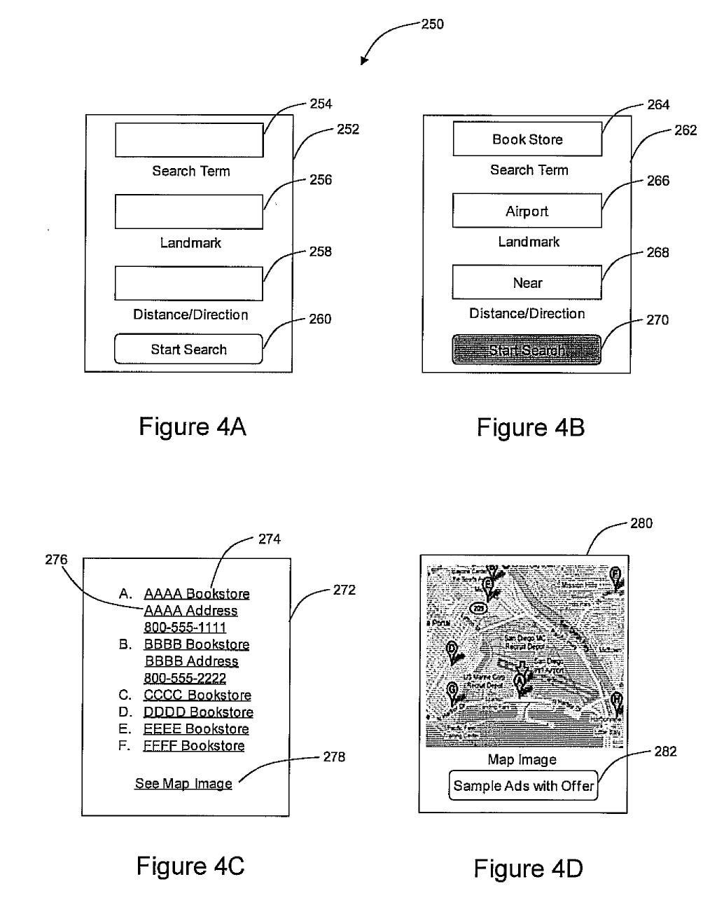

At block 230, the search results are communicated to the wireless handset 100. A hyperlink may then be provided at block 232 that enables the user to access a map such as shown in FIG. 4D. The method may also include generating a map that displays the location for each of the search results. Additionally, an advertisement may be associated with the search results corresponding to the landmark. Furthermore, the advertisement may include an offer from a similar shop. Further still, the map may include an advertisement that is obtained by accessing the third party server 166.

Referring to FIGS. 4A-4D there are shown illustrative screenshots 250 for enabling the wireless handset to perform a mobile search with a landmark. In FIG. 4A an illustrative screen shot 252 is presented that is adapted to receive the first search text string 254, a second landmark text string 256, a third search string 258 that that includes a distance search string and/or a directional search string as described above. Additionally, a start search button 260 is provided.

In FIG. 4B, an illustrative screenshot 262 is presented with the various fields having text input. More particularly, in screenshot 262 the first text string 264 is filled in with the text string “Book Store.” The second landmark text string 266 indicates that the illustrative landmark is the “Airport.” In another illustrative example, the second landmark text string may include at least two landmarks, e.g. “Airport” and “Museum of Contemporary Art.” The third search string 268 provides includes an illustrative distance term, namely, “near.” In yet another illustrative example, the third search string may include at least two distance/direction terms such as “near” and “between.” The start search button 270 is then activated.

In FIG. 4C, illustrative results from performing the search application described above are presented in screenshot 272. A particular bookstore 274 is identified having an address 276. Additionally, a plurality of different bookstores is also identified and some have addresses and phone numbers presented that are associated with the particular bookstore. Additionally, a map link 278 is also shown that provides a link to FIG. 4D where a map 280 is presented on the different locations for the illustrative bookstores shown in FIG. 4C. Additionally, FIG. 4D presents an illustrative sample ad below the illustrative map 280. The sample and 282 may also include an offer from a nearby bookstore.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A wireless handset operatively coupled to a network that enables the wireless device to communicate with a search engine, wherein the wireless device comprises:
a processor;
a keyboard operatively coupled to the processor, wherein the keyboard is configured to receive a plurality of text;
a display operatively coupled to the processor, wherein the display presents the plurality of text received by the keyboard;
a first search text string received from the keyboard, wherein the first search text string is associated with a search term;
a second landmark text string received from the keyboard, wherein the landmark text string is associated with a landmark having a particular location;
a means for communicating the first search text string and the second landmark text string to the search engine using the network; and
a means for receiving a search result that includes a search result having at least one address that corresponds to the search term and the landmark.

2. The wireless handset of claim 1 further comprising a third distance search string that associates a distance with the first search text string and the second landmark text string.

3. The wireless handset of claim 1 further comprising a third directional search string that associates a direction with the first text string and the second landmark text string.

4. The wireless handset of claim 1 further comprising a third search string that includes,
a distance search string that associates a distance with the first search text string and the second landmark text string; and
a directional search string that associates a direction with the first text string and the second landmark text string.

5. The wireless handset of claim 1 further comprising a map that is displayed on the wireless handset, wherein the map displays the location for each of the search results.

6. The wireless handset of claim 5 further comprising associating an advertisement with the search results corresponding to the landmark in the particular location.

7. A wireless handset operatively coupled to a network that enables the wireless device to communicate with a search engine, wherein the wireless device comprises:
a processor;
a keyboard operatively coupled to the processor, wherein the keyboard is configured to receive a plurality of text;
a display operatively coupled to the processor, wherein the display presents the plurality of text received by the keyboard;
a first search text string received from the keyboard, wherein the first search text string is associated with a shop;
a second landmark text string received from the keyboard, wherein the landmark text string is associated with a landmark having a particular location;
a means for communicating the first search text string and the second landmark text string to the search engine using the network; and
a means for receiving a search result that includes a search result having at least one address that corresponds to the shop and the landmark.

8. The wireless handset of claim 7 further comprising a third distance search string that associates a distance with the first search text string and the second landmark text string.

9. The wireless handset of claim 7 further comprising a third directional search string that associates a direction with the first text string and the second landmark text string.

10. The wireless handset of claim 7 further comprising a third search string that includes,
a distance search string that associates a distance with the first search text string and the second landmark text string; and
a directional search string that associates a direction with the first text string and the second landmark text string.

11. The wireless handset of claim 7 further comprising a map that is displayed on the wireless handset, wherein the map displays the location for each of the search results.

12. The wireless handset of claim 11 further comprising associating an advertisement with the search results corresponding to the landmark in the particular location.

13. The wireless handset of claim 12 wherein the advertisement includes an offer from a similar shop.

14. A method for enabling a wireless handset to determine an address with a landmark, the method comprising:
receiving a first search text string from a keyboard associated with the wireless handset;
receiving a second landmark text string from the keyboard, wherein the landmark text string is associated with a landmark having a particular location;
processing the first search text string and the second landmark text string with a processor corresponding to the wireless handset that is operatively coupled to the keyboard and a display;
displaying the first search text string and the second landmark text string on the display;
communicating the first search text string and the second landmark text string to a search engine with a wide area network; and
generating a search result that is presented on the display, wherein the search result has at least one address that corresponds to the search term and the landmark.

15. The method of claim 14 first search text string is associated with a shop.

16. The method of claim 15 further comprising receiving a third distance search string that associates a distance with the first search text string and the second landmark text string.

17. The method of claim 15 further comprising receiving a third directional search string that associates a direction with the first text string and the second landmark text string.

18. The method of claim 15 further comprising receiving a third search string that includes,
a distance search string that associates a distance with the first search text string and the second landmark text string; and
a directional search string that associates a direction with the first text string and the second landmark text string.

19. The method of claim 14 further comprising generating a map that is displayed on the wireless handset, wherein the map displays the location for each of the search results.

20. The method of claim 19 further comprising associating an advertisement with the search results corresponding to the landmark in the particular location.

21. The method of claim 20 wherein the advertisement includes an offer from a similar shop.
